(19) United States
(12) Patent Application Publication
(10) Pub. No.: US 2004/0173992 A1
(43) Pub. Date: Sep. 9, 2004

(54) Truck slide assembly

(75) Inventors: Nicholas Stunder, Prince George (CA); Blair A. Stunder, Prince George (CA)

Correspondence Address: OYEN, WIGGS, GREEN & MUTALA, 480 - THE STATION, 601 WEST CORDOVA STREET, VANCOUVER, BC, V6B 1G1, CA

(73) Assignee: Arctic Manufacturing Ltd., Prince George (CA)

(21) Appl. No.: 10/443,920

(22) Filed: May 23, 2003

(30) Foreign Application Priority Data
Mar. 7, 2003 (CA) 2,421,419

(51) Int. Cl. B62D 53/06

(52) U.S. Cl. 280/438.1

(57) ABSTRACT

The invention provides a slide assembly for coupling a trailer to a vehicle. The slide assembly comprises a platform slidably mounted on a pair of rails. At least one of the rails has a plurality of notches on the interior or exterior edge thereof. At least one jaw is pivotally mounted on the platform and configured to pivot between a locked position wherein the jaw engages the notches and a sliding position wherein the jaw is removed from the notches. An actuator is coupled to the jaw to move the jaw between the locked position and the sliding position.

### Technical Field

The invention relates to a slide assembly for a truck with a trailer, and more particularly to a slide assembly that allows the mounting point of the trailer to be quickly and easily adjusted relative to the drive axle of the truck.

### BACKGROUND

When a truck or other vehicle hauling a trailer is traveling on a dirt of gravel road, it is advantageous to have the pivot point of the trailer, which is the point where the weight of the trailer is supported by the truck, centered over the drive axle of the truck. However, it is generally required to have the pivot point of the trailer located forward of the drive axle when the truck is traveling on paved roads, in order to comply with axle load limits. Furthermore, for a truck with a large fuel tank, the distribution of weight on the axles changes as fuel is consumed, and the location of the pivot point of the trailer must be adjusted accordingly.

It is therefore desirable to provide a truck or other vehicle used to tow a trailer with apparatus for pivotally coupling the trailer to the vehicle which allows the pivot point to be longitudinally adjusted relative to the axles of the vehicle. There exist a number of prior art systems for allowing longitudinal adjustment of the pivot point of a trailer.

Existing systems typically comprise a platform, with a trailer attachment point thereon, slidably mounted on a pair of rails. Some such systems incorporate a lock strip between the rails, which is raised with respect to the rails, that has notches on top thereof, or formed therein. In other such systems, the central lock strip is in or near the same plane as the rails. The notches on such a strip are vulnerable to becoming filled with material such as mud, snow and ice during adverse conditions. Accumulation of material in the notches can make adjustment of the trailer attachment point extremely difficult. Furthermore, the central lock strip can interfere with service and maintenance to the truck's suspension system, components of which are typically located under the platform

There exists a need for an improved system for allowing longitudinal adjustment of the attachment point of a trailer. Such a system should preferably be reliable and easy to use.

### SUMMARY OF INVENTION

The invention provides a slide assembly for coupling a trailer to a vehicle. The slide assembly comprises a pair of rails, with at least one of the rails having a plurality of locking structures thereon. A platform is slidably mounted on the rails. At least one jaw is mounted on the platform. The jaw is configured to move between a locked position wherein the jaw engages at least one of the locking structures and a sliding position wherein the jaw is removed from the locking structures. An actuator is associated with the jaw and configured to move the jaw between the locked position and the sliding position.

The rails are preferably parallel. The locking structures preferably comprise notches. The notches are preferably formed in an edge of the at least one of the rails. The notches may be formed in either the inner or the outer edge of the rail. The jaw is preferably pivotally mounted on the platform.

More preferably, both of the rails have a plurality of notches formed in edges thereof, and there are a pair of jaws pivotally mounted on the platform. The notches may be formed in either the inner or outer edges of the rails. The jaws are configured to pivot between a locked position wherein the jaws engage the notches and a sliding position wherein the jaws are removed from the notches.

Each jaw preferably comprises at least one tooth tapered in a direction toward the nearest rail, and the locking structures preferably comprise notches shaped to conform to the tooth.

The actuator preferably comprises a cylinder coupled between the pair of jaws. The cylinder is configured to move between an extended position and a retracted position, wherein the jaws are in the locked position when the cylinder is in the extended position and the jaws are in the sliding position when the cylinder is in the retracted position. A spring is preferably coupled to the cylinder and configured to bias the cylinder into the extended position. The cylinder may be either pneumatic or hydraulic.

The invention also provides a method of longitudinally adjusting a trailer relative to a vehicle. The method comprises: providing a platform slidably mounted on a pair of rails attached to the vehicle, each of the pair of rails having a plurality of locking structures thereon, coupling the trailer to the platform; mounting a locking mechanism on the platform, the locking mechanism configured to selectively engage the locking structures; disengaging the locking mechanism from the locking structures; longitudinally moving the platform relative to the rails; and, engaging the locking structures with the locking mechanism. Mounting the locking mechanism preferably comprises pivotally mounting a pair of jaws on the platform and coupling an actuator between the pair of jaws. Disengaging the locking mechanism preferably comprises activating the actuator. Engaging the locking mechanism preferably comprises deactivating the actuator

### BRIEF DESCRIPTION OF DRAWINGS

In drawings which illustrate non-limiting embodiments of the invention:

FIG. 1 is an isometric view of the underside of a slide assembly in a locked position according to a preferred embodiment of the invention;

FIG. 2 is an isometric view of the topside of the slide assembly of FIG. 1;

FIG. 3 is an isometric view of the underside of the slide assembly of FIG. 1 in a sliding position;

FIG. 4 is an isometric view of the topside of the slide assembly of FIG. 3;

FIG. 5 is an isometric view of the underside of a slide assembly in a locked position according to an alternative embodiment of the invention;

FIG. 6 is an isometric view of the topside of the slide assembly of FIG. 5 in a sliding position;

FIG. 7 is an isometric view of the underside of a slide assembly in a locked position according to a further alternative embodiment of the invention; and,

FIG. 8 is an isometric view of the topside of the slide assembly of FIG. 7.

### DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive, sense.

The invention provides a slide assembly for adjustably coupling a trailer to a vehicle. The slide assembly comprises a platform mounted on a pair of rails which are held in fixed relation to the vehicle. A fifth wheel, bunk and bolster, or other apparatus for mounting a trailer may be attached to the top of the platform. The slide assembly has a locking mechanism thereon. The locking mechanism preferably comprises at least one jaw configured to engage notches on the edge of at least one of the pair of rails.

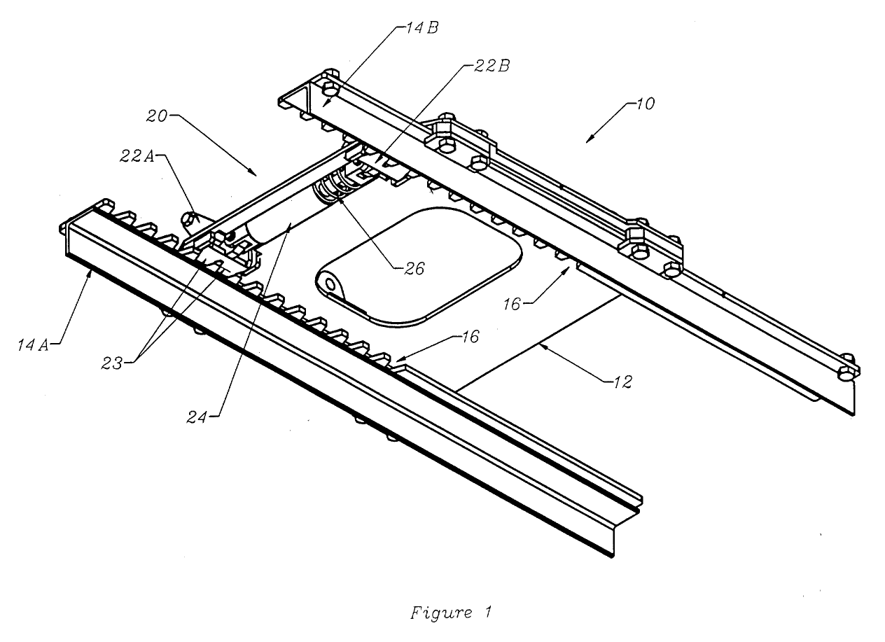

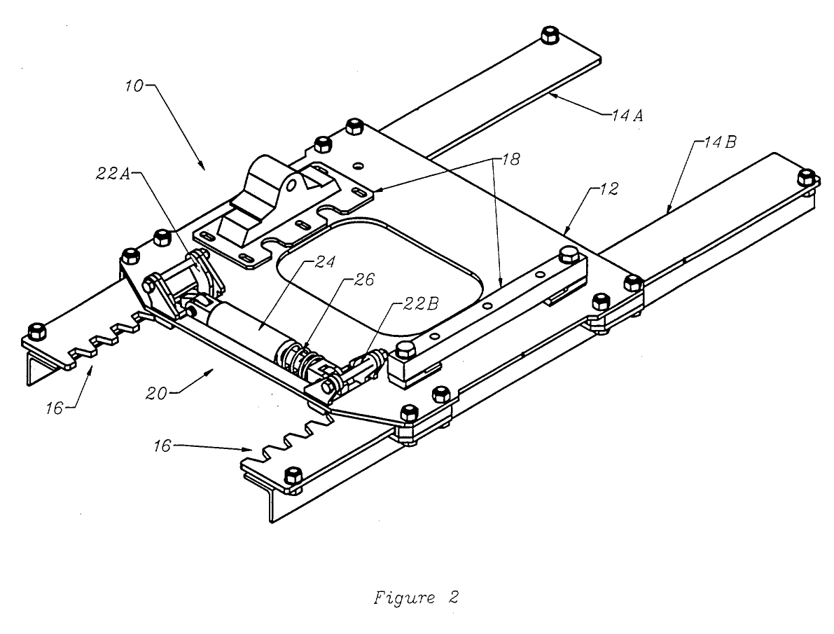

FIGS. 1 and 2 show isometric views of the underside and topside, respectively, of a slide assembly 10 according to a preferred embodiment of the invention. Slide assembly 10 comprises a platform 12 which is slidably mounted on a pair of rails 14A, 14B. At least one of rails 14A, 14B has a plurality of locking structures thereon. In the preferred embodiment, the locking structures comprise notches 16 formed on the inside edges of each of rails 14A, 14B. It is to be understood that the terms “inside” and “inward”, as used herein, refer to directions toward the midpoint between the rails, and the terms “outside” and “outward” refer to directions away from the midpoint between the rails. A mounting apparatus 18 (not shown in FIG. 1), such as a fifth wheel, bunk and bolster, or the like, may be mounted on platform 12 to facilitate attachment of the trailer (not shown).

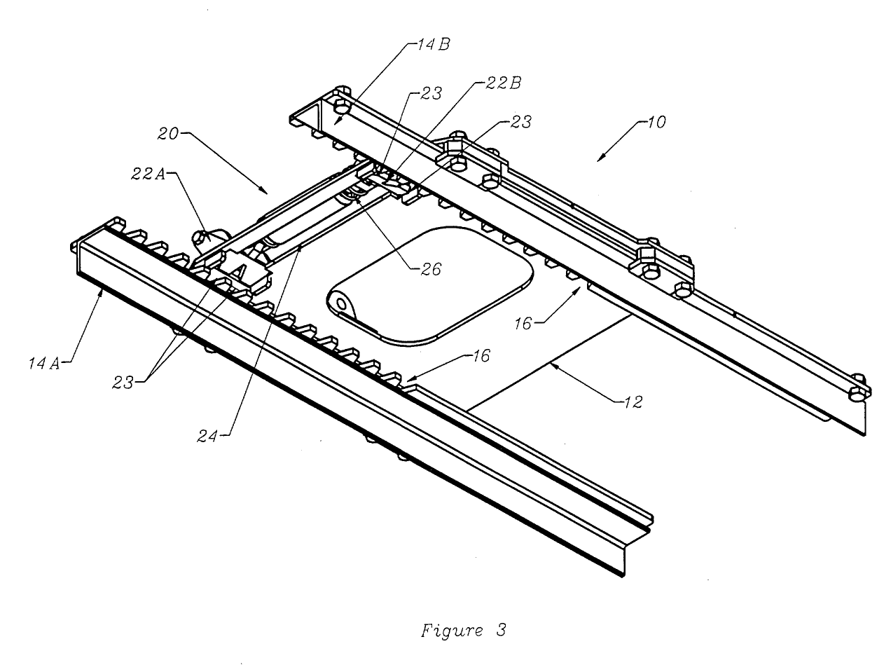

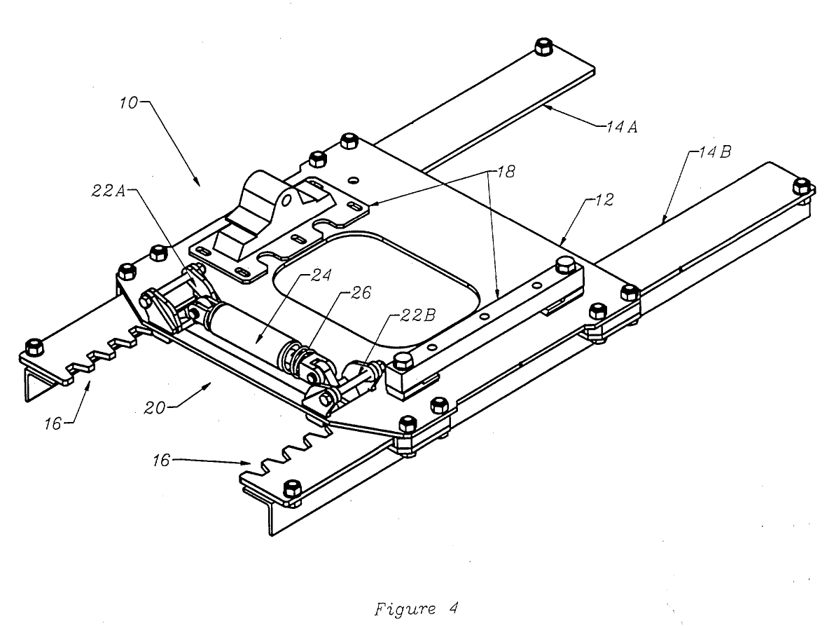

A locking mechanism 20 is mounted on platform 12. Locking mechanism 20 preferably comprises a pair of jaws 22A, 22B which are pivotally coupled to platform 12 and configured to engage notches 16. An actuator 24 is attached to jaws 22A, 22B, and configured to pivotally move jaws 22A, 22B between a locked position wherein jaws 22A, 22B engage notches 16 as shown in FIGS. 1 and 2, and a sliding position wherein jaws 22A, 22B do not engage notches 16 as shown in FIGS. 3 and 4.

Jaws 22A, 22B each preferably comprise at least one tooth 23. The Figures show two teeth 23 on each jaw 22, but it is to be understood that any number of teeth 23 is possible. In the preferred embodiment, teeth 23 are tapered in an outward direction, and notches 16 are shaped to conform to teeth 23. Providing notches 16 and teeth 23 with such a tapered configuration eliminates longitudinal movement of platform 12 relative to rails 14A, 14B when jaws 22A, 22B are in the locked position. Furthermore, the tapered configuration of notches 16 and teeth 23 reduces the likelihood that the movement of jaws 22A, 22B between the locked position and the sliding position will be hindered by the buildup of mud, snow, ice or other debris.

Actuator 24 preferably comprises a pneumatic cylinder such as the cylinder manufactured by Monarch™ Industries under Model No. 30TC03-125. Alternatively, actuator 24 may comprise a hydraulic cylinder.

Jaws 22A, 22B are preferably biased towards the locked position by a spring 26 coupled to actuator 24. Spring 26 is configured to maintain actuator 24 in an extended position as shown in FIGS. 1 and 2 unless actuator 24 is activated by a user. When activated, actuator 24 moves into a retracted position, thereby compressing spring 26 and causing jaws 22A, 22B to pivot into the sliding position as shown in FIGS. 3 and 4. The pivoting motion of jaws 22A, 22B causes actuator 24 to move upwardly as it contracts.

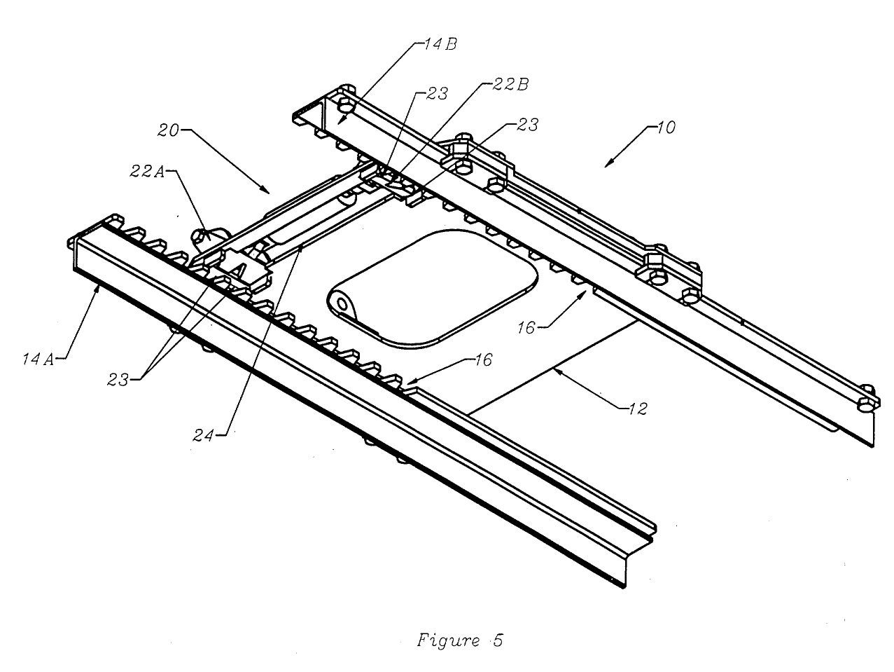

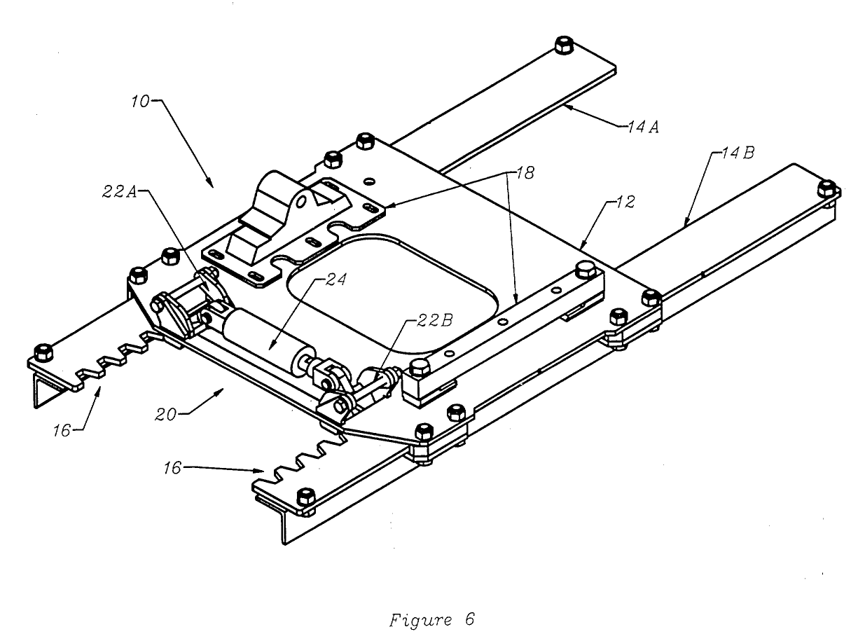

In an alternative embodiment, there is no spring coupled to actuator 24, as shown in FIGS. 5 and 6. In this embodiment, actuator 24 is configured to move jaws 22A, 22B between the locked position and the sliding position. Other than the lack of a spring, the embodiment of FIGS. 5 and 6 is identical to that of FIGS. 1 to 4.

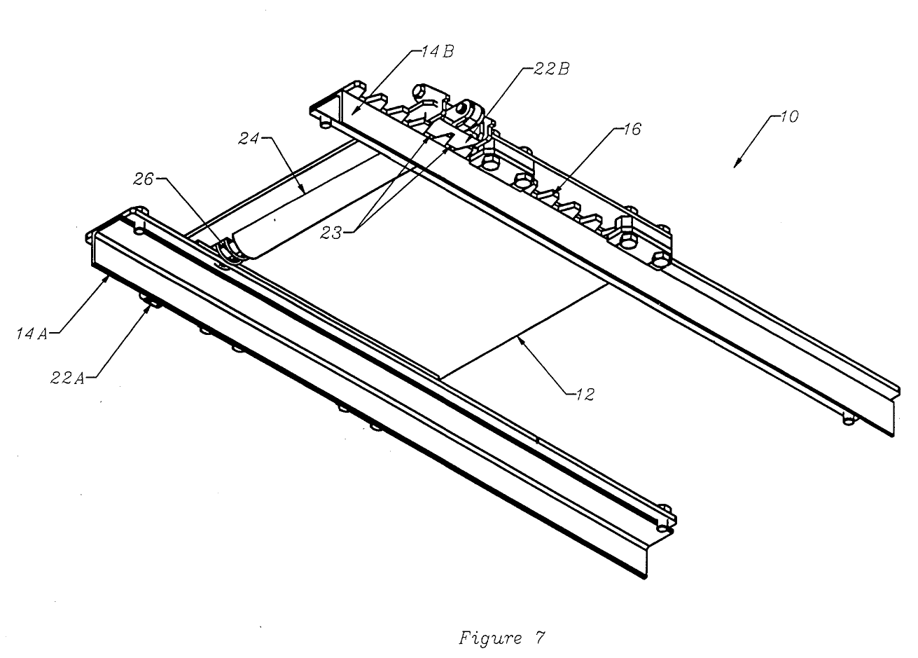

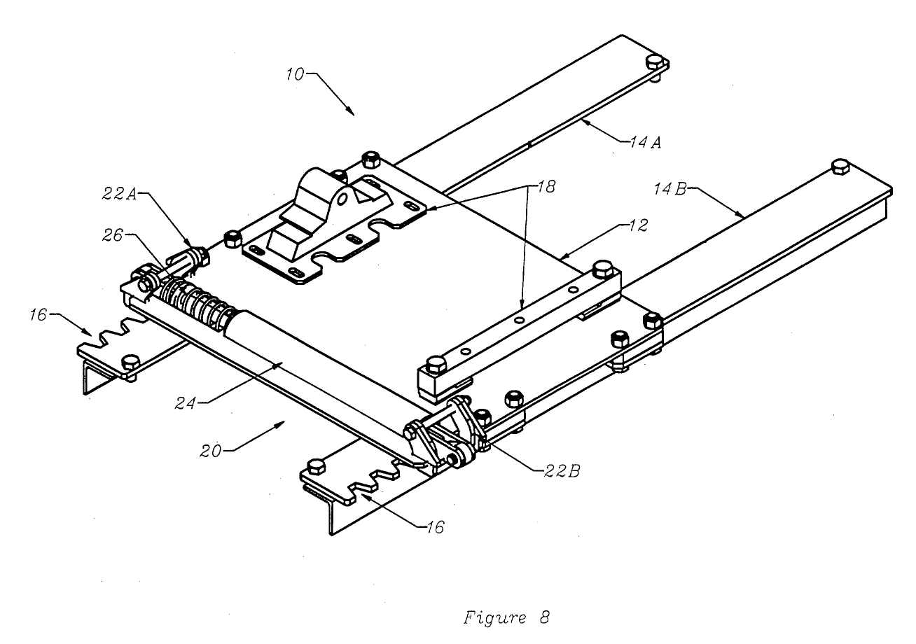

In a further alternative embodiment, the notches are on the exterior edges of the rails, as shown in FIGS. 7 and 8. In this embodiment, jaws 22A, 22B are coupled to actuator 24 such that when actuator 24 is in a retracted position, jaws 22A, 22B are in the locked position and engage notches 16, and when actuator 24 is in an extended position, jaws 22A, 22B are in the sliding position and do not engage notches 16. Spring 26 is configured to maintain actuator 24 in a retracted position (which maintains jaws 22A, 22B in the locked position) in this embodiment, as shown in FIGS. 7 and 8, unless actuator 24 is activated by a user.

To illustrate the operation of the invention, consider a truck, equipped with a slide assembly 10 according to the invention, towing a loaded trailer on a dirt road. During transport, the locking mechanism 20 is in the locked position, and trailer is typically be positioned such that the attachment point of the trailer to the truck is centered over the drive axle of the truck in order to improve traction on the dirt. When the truck moves from the dirt road to a paved road, the driver stops the truck and activates the actuator 24 to move locking mechanism 20 into the sliding position. The driver then adjusts the position of the trailer, typically by backing the truck up a small distance, so that the attachment point of the trailer is forward of the drive axle. The driver then deactivates the actuator to return locking mechanism 20 to the locked position and resumes traveling on the paved road.

As will be apparent to those skilled in the art in the light of the foregoing disclosure, many alterations and modifications are possible in the practice of this invention without departing from the spirit or scope thereof. For example, while the detailed description and the drawings contemplate notches on both of the rails, there could be notches on only one of the rails and there could be only one jaw. Accordingly, the scope of the invention is to be construed in accordance with the substance defined by the following claims.

What is claimed is:

1. A slide assembly for coupling a trailer to a vehicle, the slide assembly comprising:
(a) a pair of rails, at least one of said rails having a plurality of locking structures thereon;
(b) a platform slidably mounted on said rails;
(c) at least one jaw mounted on said platform, said jaw configured to move between a locked position wherein said jaw engages at least one of said locking structures and a sliding position wherein said jaw is removed from said locking structures; and,
(d) an actuator associated with said at least one jaw and configured to move said at least one jaw between the locked position and the sliding position.

2. The slide assembly of claim 1 wherein said rails are parallel.

3. The slide assembly of claim 1 wherein said locking structures comprise notches.

4. The slide assembly of claim 3 wherein said notches are formed in an interior edge of said at least one of said rails.

5. The slide assembly of claim 3 wherein said notches are formed in an exterior edge of said at least one of said rails.

6. The slide assembly of claim 1 wherein said at least one jaw is pivotally mounted on said platform.

7. The slide assembly of claim 1 wherein both of said rails have locking structures comprising a plurality of notches formed in interior edges thereof.

8. The slide assembly of claim 1 wherein both of said rails have locking structures comprising a plurality of notches formed in exterior edges thereof.

9. The slide assembly of one of claims 7 or 8 wherein said at least one jaw comprises a pair of jaws, both of said pair of jaws pivotally mounted on said platform and configured to pivot between a locked position wherein said jaws engage said notches and a sliding position wherein said jaws are removed from said notches.

10. The slide assembly of claim 1 wherein said at least one jaw comprises at least one tooth tapered in an outward direction, and said locking structures comprise notches shaped to conform to said at least one tooth.

11. The slide assembly of claim 9 wherein said actuator comprises a cylinder coupled between said pair of jaws, said cylinder configured to move between an extended position and a retracted position, wherein said jaws are in the locked position when said cylinder is in the extended position and said jaws are in the sliding position when said cylinder is in the retracted position.

12. The slide assembly of claim 11 further comprising a spring coupled to said cylinder and configured to bias said cylinder into the extended position.

13. The slide assembly of claim 11 or 12 wherein said cylinder comprises a pneumatic cylinder.

14. The slide assembly of claim 11 or 12 wherein said cylinder comprises a hydraulic cylinder.

15. A method of longitudinally adjusting a trailer relative to a vehicle, the method comprising:
(a) providing a platform slidably mounted on a pair of rails attached to said vehicle, each of said pair of rails having a plurality of locking structures thereon;
(b) coupling said trailer to said platform;
(c) mounting a locking mechanism on said platform, said locking mechanism configured to selectively engage said locking structures;
(d) disengaging said locking mechanism from said locking structures;
(e) longitudinally moving said platform relative to said rails; and,
(f) engaging said locking structures with said locking mechanism.

16. The method of claim 15 wherein mounting said locking mechanism comprises pivotally mounting a pair of jaws on said platform and coupling an actuator between said pair of jaws.

17. The method of claim 16 wherein disengaging said locking mechanism comprises activating said actuator.

18. The method of claim 17 wherein engaging said locking mechanism comprises deactivating said actuator.
